(19) United States
(12) Patent Application Publication
(10) Pub. No.: US 2025/0211330 A1
(43) Pub. Date: Jun. 26, 2025

(54) APPARATUS AND METHOD FOR DETERMINING OPTICAL PHASE DIFFERENCE OF SUB SIGNAL OF OPTICAL TRANSMITTER

(71) Applicant: Fujitsu Limited, Kawasaki-shi (JP)

(72) Inventors: Tong YE, Beijing (CN); Xiaofei SU, Beijing (CN); Zhenning TAO, Beijing (CN)

(73) Assignee: Fujitsu Limited, Kawasaki-shi (JP)

(21) Appl. No.: 18/981,869

(22) Filed: Dec. 16, 2024

(30) Foreign Application Priority Data
Dec. 22, 2023 (CN) 202311788064.8

(51) Int. Cl. H04B 10/079

(52) U.S. Cl. CPC H04B 10/0795

(57) ABSTRACT

An apparatus and a method for determining an optical phase difference of a sub-signal of an optical transmitter. The method including: inputting a first input signal to a first electro-optical conversion unit, to enable the first electro-optical conversion unit to modulate to-be-modulated light according to the first input signal to obtain a first output signal; inputting a second input signal to a second electro-optical conversion unit, to enable the second electro-optical conversion unit to modulate to-be-modulated light according to the second input signal to obtain a second output signal; where correlation of the second input signal and the first input signal is not 0. The method includes performing a coherent detection operation based on the first output signal and the second output signal to obtain a first output quantity and a second output quantity; and determining an optical phase difference.

### CROSS-REFERENCE TO RELATED APPLICATIONS

This application is based on and hereby claims priority to Chinese Application No. 202311788064.8, filed Dec. 22, 2023, in the China National Intellectual Property Administration, the disclosure of which is incorporated herein by reference.

### TECHNICAL FIELD

Embodiments of the present disclosure relate to the field of optical communication technology.

### BACKGROUND

In the field of optical communication, in order to achieve a greater communication capacity, a signal rate output by a transmitter is very high, such as 100 G bauds. These signals typically include a plurality of sub-signals. For example, a dual-polarization system has two polarization components, i.e., x and y; a coherence system has an in-phase component I and a quadrature component Q; under a DAC architecture, PAM8 is a superposition of three 0/1 sequences, and each 0/1 sequence constitutes a sub-signal. Under modulation by a multi-modulation unit (multi-segment), a total signal is a superposition of signals of each modulation unit (segment), and a sub-signal is formed on each modulation unit. In terms of hardware implementation, these sub-signals are typically generated by different electrical and optical components, so different sub-signals may have different analog characteristics, for example, there are different optical phases between different sub-signals. Under particular circumstances, optical phases of these sub-signals should meet a certain relationship, for example, in a coherent transmitter, an optical phase difference between an in-phase component and a quadrature component should be 90 degrees; and an optical phase difference between in-phase superposed sub-signals should be 0 degree.

It should be noted that the above introduction to the technical background is just to facilitate a clear and complete description of the technical solutions of the present disclosure, and is elaborated to facilitate the understanding of persons skilled in the art, it cannot be considered that these technical solutions are known by persons skilled in the art just because these solutions are elaborated in the Background of the present disclosure.

### SUMMARY

According to one aspect of the embodiments of the present disclosure, an apparatus for determining an optical phase difference of a sub-signal of an optical transmitter is provided. The apparatus includes: a memory; and a processor coupled to the memory to: input a first input signal to a first electro-optical conversion unit, to enable the first electro-optical conversion unit to modulate to-be-modulated light according to the first input signal and to obtain a first output signal; and input a second input signal to a second electro-optical conversion unit, to enable the second electro-optical conversion unit to modulate to-be-modulated light according to the second input signal and to obtain a second output signal, wherein correlation of the second input signal and the first input signal is not 0.

The processor is configured to perform a coherent detection operation based on the first output signal and the second output signal to obtain a first output quantity and a second output quantity; and determine an optical phase difference of an output signal of the first electro-optical conversion unit and an output signal of the second electro-optical conversion unit according to the first output quantity and the second output quantity.

According to one aspect of the embodiments of the present disclosure, a method for determining an optical phase difference of a sub-signal of an optical transmitter is provided, the method including: inputting a first input signal to a first electro-optical conversion unit, to enable the first electro-optical conversion unit to modulate to-be-modulated light according to the first input signal and to obtain a first output signal; inputting a second input signal to a second electro-optical conversion unit, to enable the second electro-optical conversion unit to modulate to-be-modulated light according to the second input signal and to obtain a second output signal, wherein correlation of the second input signal and the first input signal is not 0. The method includes performing a coherent detection operation based on the first output signal and the second output signal to obtain a first output quantity and a second output quantity; and determining an optical phase difference of an output signal of the first electro-optical conversion unit and an output signal of the second electro-optical conversion unit according to the first output quantity and the second output quantity.

Referring to the later description and drawings, specific implementations of the embodiments of the present disclosure are disclosed in detail, indicating a manner that the principle of the embodiments of the present disclosure may be adopted. It should be understood that the implementations of the present disclosure are not limited in terms of a scope. Within the scope of the spirit and terms of the attached claims, the implementations of the present disclosure include many changes, modifications and equivalents.

### BRIEF DESCRIPTION OF DRAWINGS

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art can further obtain other implementations based on the drawings under the premise that they do not pay inventive labor. In the drawings:

FIG. 1 is a schematic diagram of a method for determining an optical phase difference of a sub-signal of an optical transmitter in the embodiments of the present disclosure;

FIG. 2A, 2B, 2C to FIG. 2D are schematic diagrams of a first electro-optical conversion unit in the embodiments of the present disclosure;

FIG. 2E is a schematic diagram of a second electro-optical conversion unit in the embodiments of the present disclosure;

FIG. 3 is a schematic diagram which a second input signal operates at intervals in the embodiments of the present disclosure;

FIG. 4 is a schematic diagram of a low-speed coherent detection unit in the embodiments of the present disclosure;

FIG. 5A is a block diagram of a first electro-optical conversion unit, a second electro-optical conversion unit and a low-speed coherent detection unit provided in the embodiments of the present disclosure;

FIG. 5B is a schematic diagram of a hardware structure corresponding to the block diagram in FIG. 5A, as provided by the embodiments of the present disclosure;

FIG. 6A is another block diagram of a first electro-optical conversion unit, a second electro-optical conversion unit and a low-speed coherent detection unit provided in the embodiments of the present disclosure;

FIG. 6B is a schematic diagram of a hardware structure corresponding to the block diagram in FIG. 6A, as provided by the embodiments of the present disclosure;

FIG. 7 is a curve of a monitored optical phase difference and a calculated optical phase difference provided in the present disclosure;

FIG. 8 is a schematic diagram of a method for determining an optical phase difference of a sub-signal of an optical transmitter in the embodiments of the present disclosure;

FIG. 9 is a partial schematic diagram of a hardware structure for implementation of the method shown in FIG. 8, in the embodiments of the present disclosure;

FIG. 10A is a schematic diagram of a hardware structure obtained by combining FIG. 9 with FIG. 5B;

FIG. 10B is a schematic diagram of a hardware structure obtained by combining FIG. 9 with FIG. 6B;

FIG. 11 is a schematic diagram of an apparatus for determining an optical phase difference of a sub-signal of an optical transmitter in the embodiments of the present disclosure; and

FIG. 12 is a schematic diagram of an electronic device in the embodiments of the present disclosure.

### DETAILED DESCRIPTION

Referring to the drawings, through the following Specification, the above and other features of the embodiments of the present disclosure will become obvious. The Specification and the figures specifically disclose particular implementations of the present disclosure, showing partial implementations which can adopt the principle of the embodiments of the present disclosure. It should be understood that the present disclosure is not limited to the described implementations, on the contrary, the embodiments of the present disclosure include all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ” the term “based on” should be understood as “at least partially based on . . . ”, unless the context clearly indicates otherwise.

Features that are described and/or illustrated with respect to one implementation may be used in the same way or in a similar way in one or more other implementations and in combination with or instead of the features in the other implementations. The term “comprise/include” when being used herein refers to the presence of a feature, a whole piece, a step or a component, but does not exclude the presence or addition of one or more other features, whole pieces, steps or components.

However, the inventor finds that under particular circumstances, if optical phases of sub-signals of an optical transmitter does not meet a desired phase relationship, an output signal of the optical transmitter may be distorted, or interference between different sub-signals occurs, resulting in reduction of the performance of a communication system, therefore, it is very necessary to monitor a phase difference between sub-signals in the optical transmitter. However, currently, there is no simple and feasible method to estimate an optical phase difference between a sub-signal and a reference signal, and between sub-signals.

For at least one of the above technical problems, the embodiments of the present disclosure provide an apparatus and a method for determining an optical phase difference of a sub-signal of an optical transmitter. Using coherent detection quantities of a high-speed sub-signal and another high-speed signal in a communication process of the optical transmitter to indicate an optical phase difference of the optical transmitter or an electro-optical conversion unit of the optical transmitter, implementation is simple, an implementation mode is flexible, and a use range is wide.

Accordingly, detection of an optical phase difference of a sub-signal may be realized simply and flexibly, and use of a high-speed device is avoided.

One of advantageous effects of the embodiments of the present disclosure includes: in the present disclosure, an optical phase difference is determined using a signal output by an electro-optical conversion unit of an optical transmitter, there is no need for the optical transmitter to transmit a special signal, implementation is simple; in the present disclosure, a low-speed electrical device is be used to implement monitoring of an optical phase difference of sub-signals of the optical transmitter, avoiding use of a high-speed equipment, and the low-speed electrical device may be set up in an integrated or non-integrated way, an implementation mode is flexible; in addition, the present disclosure is applicable to sub-signal optical phase difference monitoring in a variety of optical transmitters, application scenarios is diverse.

### Embodiments of a First Aspect

Embodiments of the present disclosure provide a method for determining an optical phase difference of a sub-signal of an optical transmitter. FIG. 1 is a schematic diagram of a method for determining an optical phase difference of a sub-signal of an optical transmitter in the embodiments of the present disclosure. As shown in FIG. 1, the method includes:
101, inputting a first input signal to a first electro-optical conversion unit, so that the first electro-optical conversion unit modulates to-be-modulated light according to the first input signal and to obtain a first output signal;
102, a second input signal is input to a second electro-optical conversion unit, to enable the second electro-optical conversion unit to modulate to-be-modulated light according to the second input signal and to obtain a second output signal, wherein correlation of the second input signal and the first input signal is not 0;
103, a coherent detection operation is performed based on the first output signal and the second output signal to obtain a first output quantity and a second output quantity; and
104, an optical phase difference of an output signal of the first electro-optical conversion unit and an output signal of the second electro-optical conversion unit is determined according to the first output quantity and the second output quantity.

It should be noted that the above FIG. 1 only schematically describes the embodiments of the present disclosure, but the present disclosure is not limited to this. For example, some of the above operations may be performed simultaneously or in a sequential order, an execution of each operation may be adjusted appropriately, moreover other some operations may be increased or reduced. Persons skilled in the art may make appropriate modifications according to the above contents, not limited to the records in the above FIG. 1.

In the operation 101, a first input signal is input to a first electro-optical conversion unit, so that the first electro-optical conversion unit modulates to-be-modulated light according to the first input signal to obtain a first output signal.

In some embodiments, the first input signal may be any signal, and it is denoted as a first input signal A[n] in the present disclosure. The first input signal A[n] may be a discrete symbol sequence or a continuous signal, where, n denotes a time sequence number. The first electro-optical conversion unit modulates to-be-modulated light input thereto according to the first input signal A[n] to obtain a first output signal, the first output signal is a high-speed signal and an optical signal. The to-be-modulated light e.g., is direct current light, or an optical signal output by an upper level unit connected to the first electro-optical conversion unit.

In some embodiments, the first electro-optical conversion unit is a unit with a modulation function and being capable of generating a high-speed signal. For example, the first electro-optical conversion unit is an optical transmitter per se, in this case, the first output signal is a total output optical signal of the optical transmitter. The first electro-optical conversion unit may further be a partial modulation unit of the optical transmitter, in this case, the first output signal is a part of the total output optical signal of the optical transmitter, that is, the first output signal is included in the total output optical signal of the optical transmitter. The optical transmitter includes but is not limited to a coherent transmitter, an intensity modulation transmitter, a phase modulator, a combination signal transmitter based on an optical frequency comb.

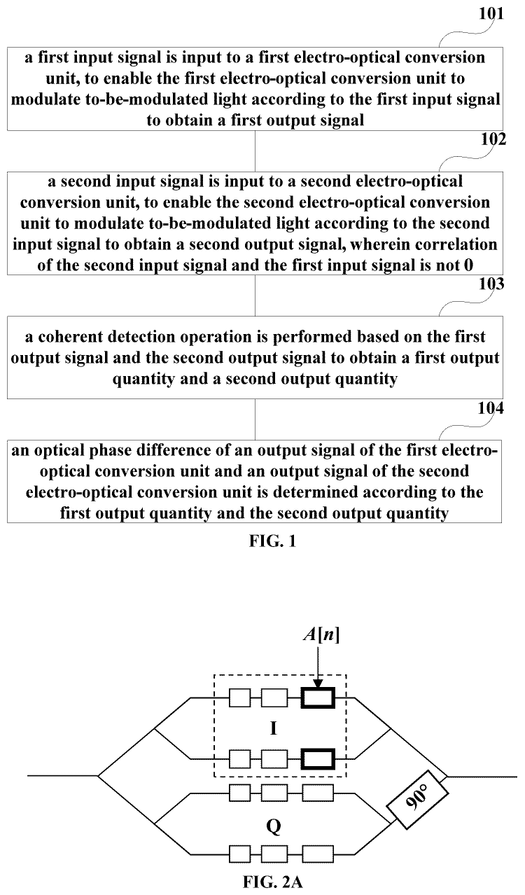

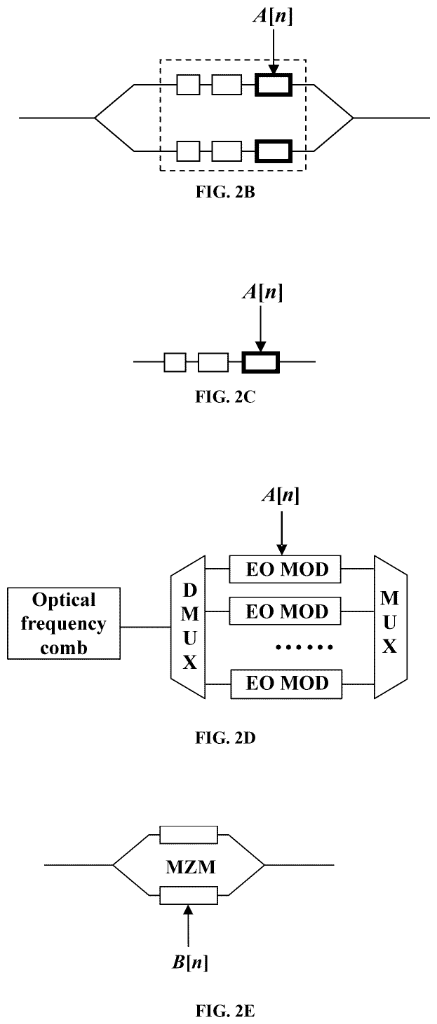

FIG. 2A, 2B, 2C to FIG. 2D are schematic diagrams of a first electro-optical conversion unit in the embodiments of the present disclosure. FIG. 2A shows an IQ modulator with a plurality of sub-signal branches in a coherent transmitter, both I channel and Q channel of the IQ modulator have a plurality of modulation units. The first electro-optical conversion unit in FIG. 2A may be any one modulation unit in the IQ modulator, such as a modulation unit corresponding to the first symbol sequence A[n] on the I channel, that is, a modulation unit input by the first symbol sequence A[n]. In FIG. 2B, the first electro-optical conversion unit is a modulation unit corresponding to the first symbol sequence A[n] in a segmented intensity modulator. In FIG. 2C, the first electro-optical conversion unit is a modulation unit corresponding to the first symbol sequence A[n] in a segmented phase modulator. In FIG. 2D, the first electro-optical conversion unit is an EO MOD unit corresponding to the first symbol sequence A[n] in a combination signal transmitter based on an optical frequency comb. In addition to the structures shown in FIG. 2A to FIG. 2D, the first electro-optical conversion unit may further adopt other structures, the present disclosure has no limitation in this regard.

In the operation 102, a second input signal is input to a second electro-optical conversion unit, so that the second electro-optical conversion unit modulates to-be-modulated light according to the second input signal to obtain a second output signal, wherein correlation of the second input signal and the first input signal is not 0.

In some embodiments, the second input signal is a signal whose correlation with the first input signal is not 0, and it is denoted as a second input signal B[n] in the present disclosure, where, n denotes a time sequence number. The second electro-optical conversion unit modulates to-be-modulated light input thereto according to the second input signal B[n] to obtain a second output signal, the second output signal is also a high-speed signal and an optical signal. The to-be-modulated light of the second electro-optical conversion unit may be the same as or different from the to-be-modulated light corresponding to the first electro-optical conversion unit.

In some embodiments, the second input signal is same as the first input signal, that is, B[n]=A[n]. In this case, the second input signal has a largest correlation with the first input signal.

In some embodiments, the second input signal is a weighted sum of the first input signal at a plurality of different moments, that is, B[n]=ΣₖcᵢA[n-nᵢ], wherein, 1≤i≤k, i and k are positive integers, nᵢ is an integer, cᵢ is a weighting coefficient corresponding to A[n-nᵢ]; and when i≠j, nᵢ≠nⱼ, where 1≤j≤k, j is a positive integer.

For example, assuming k=2, the first input signal A[n] at two different moments is denoted as A[n-n₁] and A[n-n₂] respectively, and weighting coefficients corresponding to the A[n-n₁] and A[n-n₂] are denoted as c₁ and c₂ respectively, wherein n₁ and n₂ are integers and n₁≠n₂. Then, the second input signal B[n] is a weighted sum of A[n-n₁] and A[n-n₂], that is, B[n] =c₁A[n-n₁]+c₂A[n-n₂]. If k takes other values, B[n] is calculated in a similar way, which is not described in details here.

In some embodiments, the second input signal is a symbol sequence of a weighted sum of the first input signal at a plurality of different moments, that is, B[n]=sign(93 ₖcᵢA[n-nᵢ]), where, 1≤i≤k, i and k are positive integers, nᵢ is an integer, cᵢ is a weighting coefficient corresponding to A[n-nᵢ]; and when i≠j, nᵢ≠nⱼ, where 1≤j≤k, j is a positive integer; sign( ) is a symbol function.

For example, assuming k=2, the first input signal A[n] at two different moments is denoted as A[n-n₁] and A[n-n₂] respectively, and weighting coefficients corresponding to the A[n-n₁] and A[n-n₂] are denoted as c₁ and c₂ respectively, where n₁ and n₂ are integers and n₁≠n₂, and the symbol function is sign( ) Then, the second input signal B[n] is a symbol sequence of a weighted sum of A[n-n₁] and A[n-n₂], that is, B[n]=sign(A[n-n₁]+A[n-n₂]). If k takes other values, B[n] is calculated in a similar way, which is not described in details here.

In some embodiments, the second input signal is a product of a symbol sequence of a weighted sum of the first input signal at a plurality of different moments and a random amplitude sequence, that is, B[n]=Amp[n] *sign(93 ₖcᵢA[n-nᵢ]), where, 1≤i≤k, i and k are positive integers, nᵢ is an integer, cᵢ is a weighting coefficient corresponding to A[n-nᵢ]; and when i≠j, nᵢ≠nⱼ, wherein 1≤j≤k, j is a positive integer; sign( ) is a symbol function, and Amp[n] is a random amplitude sequence.

For example, assuming k=2, the first input signal A[n] at two different moments is denoted as A[n-n₁] and A[n-n₂] respectively, and weighting coefficients corresponding to the A[n-n₁] and A[n-n₂] are denoted as c₁ and c₂ respectively, where n₁ and n₂ are integers and n₁≠n₂, the symbol function is sign( ) and the random amplitude sequence is Amp[n]. Then, the second input signal B[n] is a product of a symbol sequence of a weighted sum of A[n-n₁] and A[n-n₂] and Amp[n], that is, B[n]=Amp[n] *sign(A[n-n₁]+A[n-n₂]), where, Amp[n] may be a finite number of amplitude sequence, or may be an infinite number of amplitude sequence; Amp[n] is e.g., a random amplitude sequence with a series of positive values.

In some embodiments, the second input signal has finite values, for example, a set of values of the second output signal may be {1,−1}, {1, 0} or {1, 0,−1}, etc. The second input signal with finite values may be implemented via the following mode:

For example, when the value of the first input signal is {1,−1}, the second input signal may be the same as the first input signal, in this case, the value of the second input signal is also {1,−1}; or, the second input signal may be a weighted sum of the first input signal at multiple different moments, in this case, the value of the second input signal is also a finite level {1, 0,−1}.

For another example, when the value of the first input signal is not {1,−1}, the second input signal may be a symbol function of the first input signal, thereby obtaining a finite number of value for {1,−1} or {1, 0,−1}.

If the value of the second input signal is {1, 0,−1}, but the input of the second electro-optical conversion unit may only take two levels, such as {1,−1}, a signal at all time positions of B[n]=0 may be replaced with a random sequence with a value being {1,−1}. Similarly, if the input of the second electro-optical conversion unit may only take a value {1, 0}, a signal at all time positions of B[n]=−1 may be replaced with a random sequence with a value being {1, 0}.

In some embodiments, the second input signal is enabled to operate at intervals. The meaning of operating at intervals is that a signal input into the second electro-optical conversion unit is not assigned a second input signal B/n/at all moments, but is assigned a second input signal B[n] at pre-set some moments. Thus, at a pre-set moment, the second input signal B[n] is input to the second electro-optical conversion unit; at a moment other than the pre-set moment, 0 signal or a signal whose correlation with the first input signal A[n] is 0 is input to the second electro-optical conversion unit.

In some embodiments, the pre-set moment may be a periodically occurring moment, that is, the second input signal operates at a fixed periodic interval. For example, FIG. 3 is a schematic diagram in which a second input signal operates at intervals in the embodiments of the present disclosure. FIG. 3 shows five rows of squares, each square in each row of squares represents a moment, and a square whose background color is white represents that a moment to which it corresponds is assigned with a signal marked on the left side of the square. As shown in FIG. 3, the first row of squares represents that at all moments, the first input signal A[n] is input to the first electro-optical conversion unit; the second row of squares represents that at all moments, the second input signal B[n] is input to the second electro-optical conversion unit; the third row of squares represents that the second input signal operates at a ½ rate interval (half-assigned B[n]), that is, by taking two moments as a period, at one moment in each period, the second input signal B[n] is input to the second electro-optical conversion unit; the fourth row of squares represents that the second input signal operates at a ¼ rate interval (¼-assigned B[n]), that is, by taking four moments as a period, at one moment in each period, the second input signal B[n] is input to the second electro-optical conversion unit; the fifth row of squares represents that the second input signal operates at a ⅛ rate interval (⅛-assigned B[n]), that is, by taking eight moments as a period, at one moment in each period, the second input signal B[n] is input to the second electro-optical conversion unit.

In practical application, a length of an interval operating period of the second input signal B[n] is not limited to the above examples.

In some embodiments, the pre-set moment may be a randomly selected moment, that is, the second input signal operates at random intervals.

In some embodiments, the second input signal operating at intervals may be any one of the above second input signals provided in the present disclosure.

In the above embodiments, by making the second input signal operate at intervals, a moment to input the second input signal is reduced, an output quantity obtained by a coherent detection operation will be also reduced correspondingly, which is conducive to reducing power consumption of an operation for determining an optical phase difference of a sub-signal of an optical transmitter.

In some embodiments, the second electro-optical conversion unit is a unit with a modulation function and being capable of generating a high-speed signal. In the present disclosure, the second electro-optical conversion unit may be an existing electro-optic conversion unit. FIG. 2E is a schematic diagram of a second electro-optical conversion unit in the embodiments of the present disclosure. In FIG. 2E, the second electro-optical conversion unit is an MZ-type modulator (MZM) with a modulation unit. Moreover, the second electro-optical conversion unit may further be an MZ-type modulator (MZM) having two modulation units with an equal length, or an electro absorption modulator (EAM), or a phase modulator (PM), or a structure in which an amplitude modulator (such as an MZ-type modulator (MZM) or an electro absorption modulator (EAM)) and a phase modulator (PM) are connected in series. In addition to the structures shown in the above examples, the second electro-optical conversion unit may further adopt other structures, the present disclosure has no limitation in this regard.

In some embodiments, the second output signal output by the second electro-optical conversion unit is a continuous signal.

In some embodiments, the second electro-optical conversion unit outputs a finite number of states, i.e., the second output signal output by the second electro-optical conversion unit is a discrete signal with finite values. For example, a set of values of the second output signal output by the second electro-optical conversion unit may be {1,−1}, {1, 0} or {1, 0,−1}.

When the second electro-optical conversion unit only outputs a finite number of states, the second electro-optical conversion unit only needs logical operation, its complexity, cost and power consumption are all reduced.

In the operation 103, a coherent detection operation is performed based on the first output signal and the second output signal to obtain a first output quantity and a second output quantity.

In some embodiments, the coherent detection operation is realized via a low-speed coherent detection unit. FIG. 4 is a schematic diagram of a low-speed coherent detection unit in the embodiments of the present disclosure. As shown in FIG. 4, the low-speed coherent detection unit includes a phase shifter (4), a 90-degree frequency mixer (90° hybrid) and two balanced detectors (BPD), in which the phase shifter (q) is optional, that is, the phase shifter may or may not be included in FIG. 4. In FIG. 4, the low-speed coherent detection unit has two input signals, i.e., signal 1 and signal 2; and, the low-speed coherent detection unit includes two output signals, namely, a first output quantity and a second output quantity are obtained according to the first output signal and the second output signal. In addition to the structure shown in FIG. 4, the low-speed coherent detection unit may further adopt other structures, the present disclosure has no limitation in this regard.

In some embodiments, the principle in which the low-speed coherent detection unit performs coherent detection operations on the input signals 1 and 2 to obtain the first output quantity and the second output quantity is provided as follows:

Assume that signal 1 is denoted by E₁ (t), signal 2 is denoted by E₂ (t), and an optical phase difference between signal 1 and signal 2 is φ. After an ideal 90-degree frequency mixer, an output optical signal may be denoted as:

$$\frac{1}{2} [ \begin{matrix}{E}_{1} ( t ) - {E}_{2} ( t ) {e}^{j φ} \\ j ( {E}_{1} ( t ) + {E}_{2} ( t ) {e}^{j φ} ) \\ j ( {E}_{1} ( t ) + j {E}_{2} ( t ) {e}^{j φ} ) \\ - ( {E}_{1} ( t ) - j {E}_{2} ( t ) {e}^{j φ} )\end{matrix} ] \qquad ( Equation 1 )$$

Subsequently, output currents of two balanced detectors may be respectively expressed as:

$$\begin{matrix}{I}_{BPD 1} ( t ) = \frac{{R}_{BPD}}{4} ( {\vert {E}_{1} ( t ) + {E}_{2} ( t ) {e}^{j φ} \vert}^{2} - {\vert {E}_{1} ( t ) - {E}_{2} ( t ) {e}^{j φ} \vert}^{2} ) \\ = {R}_{BPD} [ {E}_{1} ( t ) {E}_{2}^{*} ( t ) {e}^{- j φ} + {E}_{1}^{*} ( t ) {E}_{2} ( t ) {e}^{j φ} ] / 2\end{matrix} \qquad ( Equation 2 )$$

$$\begin{matrix}{I}_{BPD 2} ( t ) = \frac{{R}_{BPD}}{4} ( {\vert {E}_{1} ( t ) + j {E}_{2} ( t ) {e}^{j φ} \vert}^{2} - {\vert {E}_{1} ( t ) - j {E}_{2} ( t ) {e}^{j φ} \vert}^{2} ) \\ = {R}_{BPD} [ - j {E}_{1} ( t ) {E}_{2}^{*} ( t ) {e}^{- j φ} + j {E}_{1}^{*} ( t ) {E}_{2} ( t ) {e}^{j φ} ] / 2 \\ = {R}_{BPD} [ {E}_{1} ( t ) {E}_{2}^{*} ( t ) {e}^{- j ( φ + π / 2 )} + {E}_{1}^{*} ( t ) {E}_{2} ( t ) {e}^{j ( φ + π / 2 )} ] / 2\end{matrix} \qquad ( Equation 3 )$$

In the above Equation 2 and Equation 3, R_{BpD} is a response of a balanced detector. Since an electrical device such as a balanced detector is of low bandwidth and low rate, it may be considered that two output quantities of the low-speed coherent detection unit are the average of a signal, so the first output quantity and the second output quantity may be respectively expressed as:

$${I}_{1} = 〈 {I}_{BPD 1} ( t ) 〉 = \frac{{R}_{BPD}}{2} 〈 {E}_{1} ( t ) {E}_{2}^{*} ( t ) {e}^{- j φ} + {E}_{1}^{*} ( t ) {E}_{2} ( t ) {e}^{j φ} 〉 \qquad ( Equation 4 )$$

$${I}_{2} = 〈 {I}_{BPD 2} ( t ) 〉 = \frac{{R}_{BPD}}{2} 〈 {E}_{1} ( t ) {E}_{2}^{*} ( t ) {e}^{- j ( φ + π / 2 )} + {E}_{1}^{*} ( t ) {E}_{2} ( t ) {e}^{j ( φ + π / 2 )} 〉 \qquad ( Equation 5 )$$

In some embodiments, performing a coherent detection operation based on the first output signal and the second output signal includes: performing a coherent detection operation on the first output signal and the second output signal to obtain the first output quantity and the second output quantity.

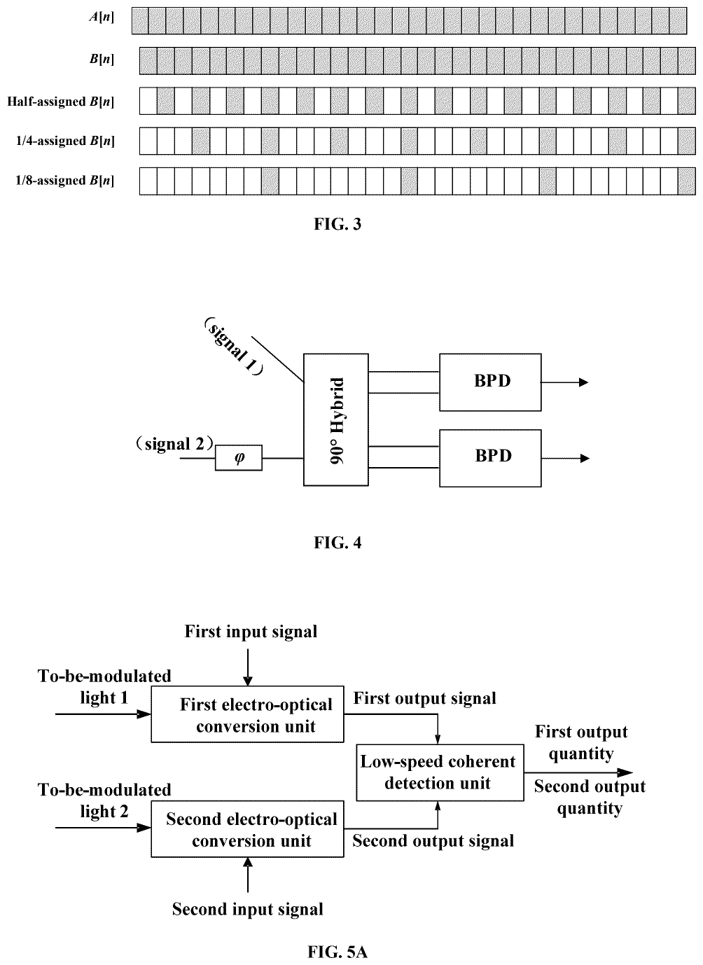

FIG. 5A is a block diagram of a first electro-optical conversion unit, a second electro-optical conversion unit and a low-speed coherent detection unit provided in the embodiments of the present disclosure. As shown in FIG. 5A, the first electro-optical conversion unit and the second electro-optical conversion unit are connected in parallel. In this case, a first input signal, i.e., a first symbol sequence A[n], is input to the first electro-optical conversion unit, so that the first electro-optical conversion unit modulates to-be-modulated light 1 and outputs a first output signal; a second input signal, i.e., a second symbol sequence B[n], is input to the second electro-optical conversion unit, so that the second electro-optical conversion unit modulates to-be-modulated light 2 and outputs a second output signal; then the first output signal and the second output signal are respectively input to a low-speed coherent detection unit for performing coherent detection operations. That is, in this embodiment, one of the signals 1 and 2 input by the low-speed coherent detection unit is an optical signal of the first output signal output by the first electro-optical conversion unit, the other of the signals 1 and 2 is an optical signal of the second output signal output by the second electro-optical conversion unit, subsequently the low-speed coherent detection unit outputs a first output quantity and a second output quantity.

FIG. 5B is a schematic diagram of a hardware structure corresponding to the block diagram in FIG. 5A, as provided by the embodiments of the present disclosure. The structure includes a first electro-optical conversion unit, a second electro-optical conversion unit and a low-speed coherent detection unit, wherein the first electro-optical conversion unit is connected in parallel to the second electro-optical conversion unit, that is, the first electro-optical conversion unit is connected to a first input end of the low-speed coherent detection unit, and inputs a first output signal to the first input end, the second electro-optical conversion unit is connected to a second input end of the low-speed coherent detection unit, and inputs the second output signal to the second input end. And, the first electro-optical conversion unit may be any one of the first electro-optical conversion units shown in FIG. 2A to FIG. 2D or other structure, the second electro-optical conversion unit may be the second electro-optical conversion unit shown in FIG. 2E or other structure, and the low-speed coherent detection unit may be the low-speed coherent detection unit shown in FIG. 4 or other structure.

For example, in the structure shown in FIG. 5B, the first electro-optical conversion unit adopts the structure shown in FIG. 2A and is a part of a transmitter, the second electro-optical conversion unit adopts the structure shown in FIG. 2E, and the low-speed coherent detection unit adopts the structure shown in FIG. 4.

In FIG. 5B, to-be-modulated light of the first electro-optical conversion unit and of the second electro-optical conversion unit are direct current light, and before a modulator, part (e.g. 95%) of the direct current light is transmitted to the first electro-optical conversion unit, and the other part (e.g. 5%) is transmitted to the second electro-optical conversion unit. A coherent transmitter is formed with a plurality of output ports via a beam splitter MMI, so a first output signal output by it may be included in an output signal I+jQ at an I+jQ detection end, or in an output signal I−jQ at an I−jQ detection end, or in an output signal of other detection branches. Acquisition of an output signal may be achieved by a beam splitter, through which a part of the output signal (e.g. 5%) is split and is applied in the present disclosure, and for details, prior arts may be referred to. FIG. 5B takes that a to-be-measured signal is included in an output signal I−jQ at an I−jQ detection end as an example, however the present disclosure is not limited to this.

After the low-speed coherent detection unit receives the first output signal and the second output signal, the first output quantity I₁ and the second output quantity I₂ are obtained according to the above Equation 1 to Equation 5, where E₁ (t) and E₂ (t) in Equation 1 to Equation 5 are the first output signal and the second output signal respectively.

In some embodiments, performing coherent detection operations based on the first output signal and the second output signal includes: performing coherent detection operations on a product of the first output signal and the second output signal as well as a pre-set reference signal to obtain the first output quantity and the second output quantity.

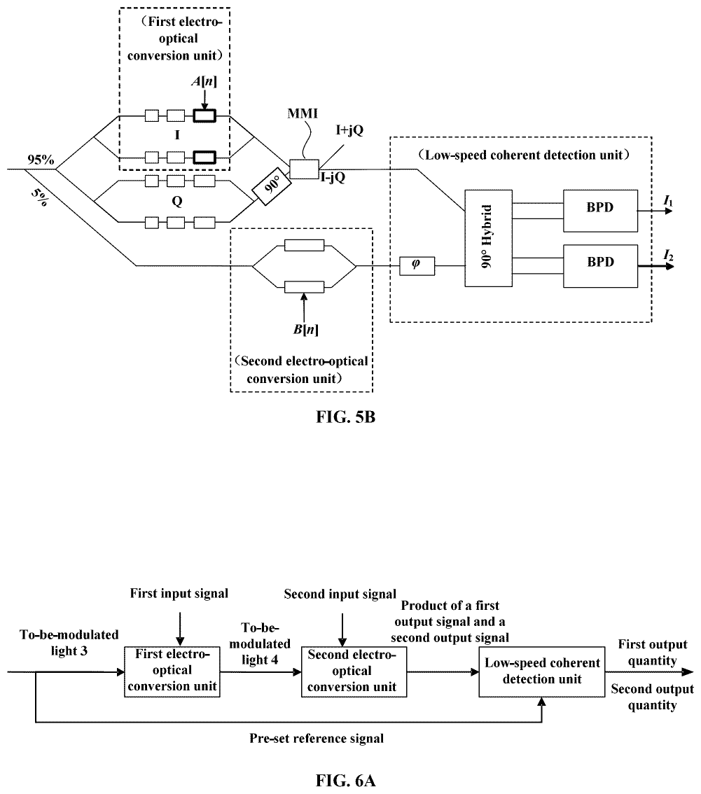

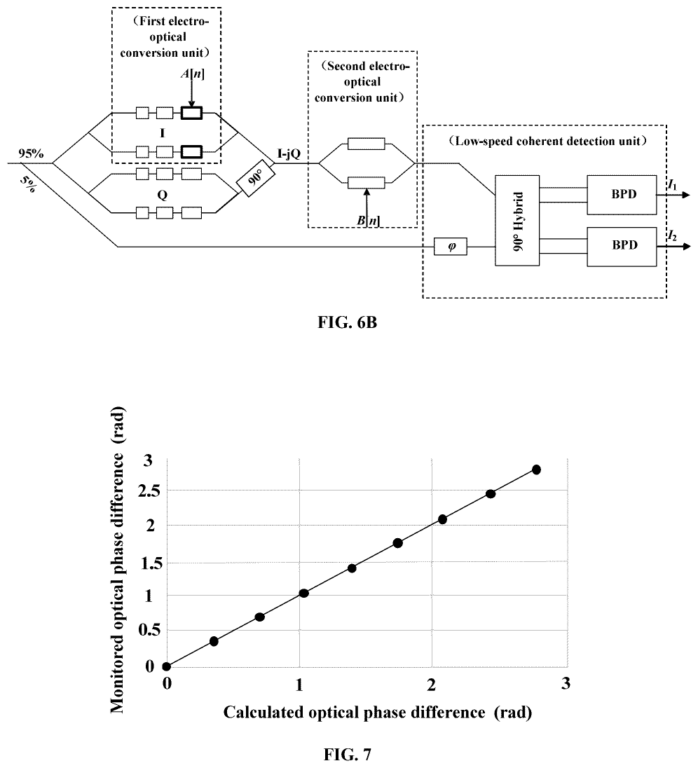

FIG. 6A is another block diagram of the first electro-optical conversion unit, the second electro-optical conversion unit and the low-speed coherent detection unit provided in the embodiments of the present disclosure. As shown in FIG. 6A, the first electro-optical conversion unit is connected in series to the second electro-optical conversion unit. In this case, a first input signal, i.e., a first symbol sequence A[n], is input to the first electro-optical conversion unit, so that the first electro-optical conversion unit modulates to-be-modulated light 3 and obtains a first output signal; a second input signal, i.e., a second symbol sequence B[n], is input to the second electro-optical conversion unit, so that the second electro-optical conversion unit modulates to-be-modulated light 4 and obtains a second output signal; as shown in FIG. 6A, when an output end of the first electro-optical conversion unit is connected in series to an input end of the second electro-optical conversion unit, the to-be-modulated light 3 may be direct current light, and the to-be-modulated light 4 includes a to-be-measured signal output by the first electro-optical conversion unit. Otherwise, when an output end of the second electro-optical conversion unit is connected in series to an input end of the first electro-optical conversion unit (not shown), the to-be-modulated light 4 may be direct current light, and the to-be-modulated light 3 includes a correlation signal output by the second electro-optical conversion unit. A series structure formed by connection in series of the first electro-optical conversion unit with the second electro-optical conversion unit outputs a product of the first output signal and the second output signal in an optical domain, that is, an optical signal of the product of the first output signal and the second output signal; then the product of the first output signal and the second output signal and a pre-set reference signal are input to the low-speed coherent detection unit for performing coherent detection operations. That is, in this embodiment, one of the signals 1 and 2 input by the low-speed coherent detection unit is an optical signal of the product of the first output signal and the second output signal, and the other one of the signals 1 and 2 is a pre-set reference signal, subsequently the low-speed coherent detection unit outputs a first output quantity and a second output quantity. The pre-set reference signal is e.g. direct current light.

FIG. 6B is a schematic diagram of a hardware structure corresponding to the block diagram in FIG. 6A, as provided by the embodiments of the present disclosure. The structure includes a first electro-optical conversion unit, a second electro-optical conversion unit and a low-speed coherent detection unit. The first electro-optical conversion unit is connected in series to the second electro-optical conversion unit, and a series structure of the first electro-optical conversion unit and the second electro-optical conversion unit is connected to the first input end of the low-speed coherent detection unit, and the product of the first output signal and the second output signal is input to the first input end, the second input end of the low-speed coherent detection unit inputs a pre-set reference signal. In addition, the first electro-optical conversion unit may be any one of the first electro-optical conversion units shown in FIG. 2A to FIG. 2D or other structure, the second electro-optical conversion unit may be the second electro-optical conversion unit shown in FIG. 2E or other structure, and the low-speed coherent detection unit may be the low-speed coherent detection unit shown in FIG. 4 or other structure.

For example, in the structure shown in FIG. 6B, the first electro-optical conversion unit adopts the structure shown in FIG. 2A and is a part of a transmitter, the second electro-optical conversion unit adopts the structure shown in FIG. 2E, and the low-speed coherent detection unit adopts the structure shown in FIG. 4.

In FIG. 6B, to-be-modulated light of the first electro-optical conversion unit and of the second electro-optical conversion unit are direct current light, and before a modulator, part (e.g. 95%) of the direct current light is transmitted to the first electro-optical conversion unit, and the other part (e.g. 5%) as a reference signal (signal 2) is input to the second input end of the low-speed coherent detection unit. A coherent transmitter has a plurality of output ports, so a to-be-measured signal output by it may be included in an output signal I+jQ at an I+jQ detection end, or in an output signal I−jQ at an I−jQ detection end, or in an output signal of other detection branches. Acquisition of an output signal may be achieved by a beam splitter, through which a part of the output signal (e.g. 5%) is split and is applied in the present disclosure, and for details, prior arts may be referred to. FIG. 6B takes that a to-be-measured signal is included in an output signal I−jQ at an I−jQ detection end as an example, however the present disclosure is not limited to this.

After the low-speed coherent detection unit receives the first output signal and the second output signal, the first output quantity I₁ and the second output quantity I₂ are obtained according to the above Equation 1 to Equation 5, where E₁ (t) in Equation 1 to Equation 5 is a product of the first output signal and the second output signal, E₂ (t) is the pre-set reference signal.

In the operation 104, an optical phase difference of an output signal of the first electro-optical conversion unit and an output signal of the second electro-optical conversion unit is determined according to the first output quantity and the second output quantity.

In some embodiments, the first output quantity and the second output quantity are substituted into the following Equation to obtain an optical phase difference of the first output signal and the second output signal:

$$φ = arg ( {I}_{1} - j {I}_{2} ) \qquad ( Equation 6 )$$

where, I₁ is the first output quantity, I₂ is the second output quantity, φ is an optical phase difference of the output signal of the first electro-optical conversion unit and the output signal of the second electro-optical conversion unit, and arg (z) is a principal argument angle of a complex number z.

And, it may be known from the above Equation 4 and Equation 5,

$${I}_{1} - j {I}_{2} = {R}_{BPD} 〈 {E}_{1}^{*} ( t ) {E}_{2} ( t ) 〉 {e}^{j φ} \qquad ( Equation 7 )$$

It may be understood that the first output signal is an output signal of the first electro-optical conversion unit, and the second output signal is an output signal of the second electro-optical conversion unit, so the optical phase difference of the first output signal and the second output signal is an optical phase difference of the output signal of the first electro-optical conversion unit and the output signal of the second electro-optical conversion unit.

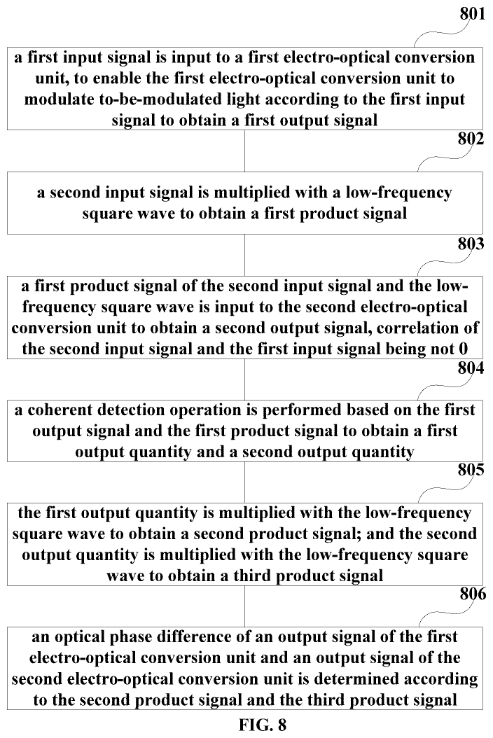

From the above embodiments, it may be seen that for any combination of the first input signal and the second input signal whose correlation therebetween is not 0, the optical phase difference q may be calculated through the method for determining an optical phase difference of a sub-signal of an optical transmitter as provided herein. FIG. 7 is a curve of a monitored optical phase difference and a calculated optical phase difference provided in the present disclosure. FIG. 7 shows that in the case of B[n]=A[n], a detected optical phase difference and a curve of an optical phase difference calculated according to the method for determining an optical phase difference of a sub-signal of an optical transmitter in the present disclosure. It may be seen from FIG. 7 that the method for determining an optical phase difference of a sub-signal of an optical transmitter in the present disclosure may accurately monitor an optical phase difference.

FIG. 8 is a schematic diagram of a method for determining an optical phase difference of a sub-signal of an optical transmitter in the embodiments of the present disclosure. As shown in FIG. 8, the method includes:
801, a first input signal is input to a first electro-optical conversion unit, to enable the first electro-optical conversion unit to modulate to-be-modulated light according to the first input signal to obtain a first output signal;
802, a second input signal is multiplied with a low-frequency square wave to obtain a first product signal;
803, a first product signal of the second input signal and the low-frequency square wave is input to the second electro-optical conversion unit to obtain a second output signal, correlation of the second input signal and the first input signal being not 0;
804, a coherent detection operation is performed based on the first output signal and the first product signal to obtain a first output quantity and a second output quantity;
805, the first output quantity is multiplied with the low-frequency square wave to obtain a second product signal; and the second output quantity is multiplied with the low-frequency square wave to obtain a third product signal; and
806, an optical phase difference of the output signal of the first electro-optical conversion unit and the output signal of the second electro-optical conversion unit is determined according to the second product signal and the third product signal.

It should be noted that the above FIG. 8 only schematically describes the embodiments of the present disclosure, but the present disclosure is not limited to this. For example, some of the above operations may be performed simultaneously or in a sequential order, an execution of each operation may be adjusted appropriately, moreover other some operations may be increased or reduced. Persons skilled in the art may make appropriate modifications according to the above contents, not limited to the records in the above FIG. 8.

In some embodiments, in operation 801, the first input signal is an input symbol sequence of the first electro-optical conversion unit, i.e., a first input symbol sequence A[n]. The first electro-optical conversion unit is a transmitter per se, or a partial modulation unit of the transmitter, the first electro-optical conversion unit is, for example, the structure shown in FIG. 2A to FIG. 2D or other structure. The first output signal is a high-speed signal and is an optical signal. For contents related to the first input signal, the first electro-optical conversion unit and the first output signal, see implementation of operation 101.

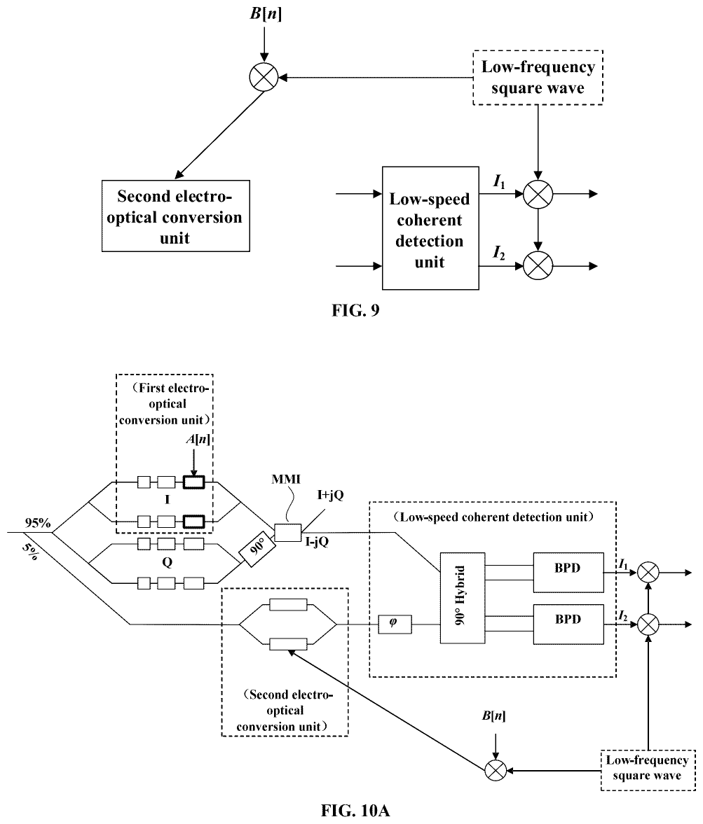

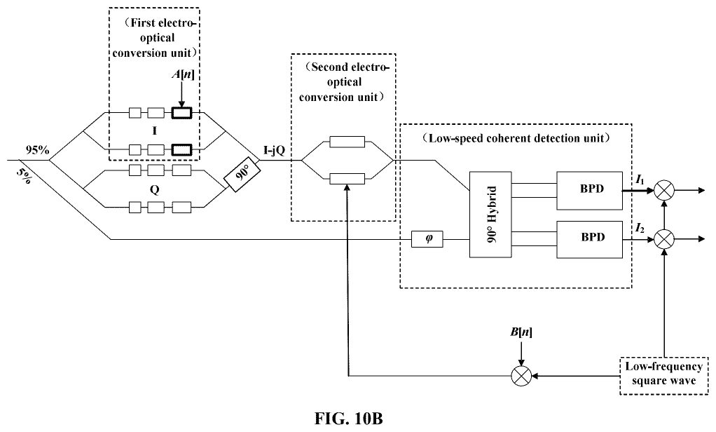

In some embodiments, in operation 802, multiplication of the second input signal with a low-frequency square wave may be implemented by e.g. a multiplier. FIG. 9 is a partial schematic diagram of a hardware structure for implementation of the method shown in FIG. 8, in the embodiments of the present disclosure. As shown in FIG. 9, the second input signal B[n] is multiplied with the low-frequency square wave, then a product of B[n] and the low-frequency square wave as a symbol sequence of the second electro-optical conversion unit is input into the second electro-optical conversion unit. Although hardware structures of the first electro-optical conversion unit, the second electro-optical conversion unit and the low-speed coherent detection unit, etc. are not shown in FIG. 9, persons skilled in the art should understand that FIG. 9 may be combined with the hardware structures shown in FIG. 5B and FIG. 6B. For example, FIG. 10A is a schematic diagram of a hardware structure obtained by combining FIG. 9 with FIG. 5B, FIG. 10B is a schematic diagram of a hardware structure obtained by combining FIG. 9 with FIG. 6B. Please refer to FIG. 5B for the description of each hardware structure in FIG. 10A, and please refer to FIG. 6B for the description of each hardware structure in FIG. 10B, which will not be repeated here.

In some embodiments, in operation 803, the second electro-optical conversion unit is, for example, the structure shown in FIG. 2E or other structure. The second input signal is also a high-speed signal and is an optical signal. For contents related to the second input signal, the second electro-optical conversion unit and the second output signal, see implementation of operation 102.

In some embodiments, in operation 804, coherent detection operations are performed based on the first output signal and the first product signal to obtain a first output quantity and a second output quantity. For contents related to the coherent detection operations, see implementation of operation 103.

In some embodiments, in operation 805, the first output quantity is multiplied with the low-frequency square wave to obtain a second product signal; and the second output quantity is multiplied with the low-frequency square wave to obtain a third product signal, for example which may be implemented via a multiplier. The low-frequency square wave in this operation and the low-frequency square wave in operation 802 are the same low-frequency square wave. For example, as shown in FIG. 10A and FIG. 10B, a multiplier is connected to two output ends of the low-speed coherent detection unit respectively to achieve multiplication of the first output quantity with the low-frequency square wave and multiplication of the second output quantity with the low-frequency square wave.

In some embodiments, in operation 806, an optical phase difference of the output signal of the first electro-optical conversion unit and the output signal of the second electro-optical conversion unit is determined according to the second product signal and the third product signal. For contents related to calculation of the optical phase difference, see implementation of operation 104.

Through the above embodiments, in the present disclosure, an operation of multiplying a square wave with a frequency shift is added to a method for determining an optical phase difference of a sub-signal of an optical transmitter, i.e., a first product signal obtained by multiplying a low-frequency square wave with a symbol sequence serves as a symbol sequence of a second electro-optical conversion unit, and a first output quantity and a second output quantity obtained via a coherent detection operation are multiplied with the low-frequency square wave respectively to obtain a second product signal and a third product signal, and based on the second product signal and the third product signal, an optical phase difference of the output signal of the first electro-optical conversion unit and the output signal of the second electro-optical conversion unit is determined. After the operation of multiplying a square wave with a frequency shift is added, the first output quantity and the second output quantity obtained by calculation may be transferred from DC to a frequency of the low-frequency square wave, so as to avoid 1/f noise near DC.

The above text schematically describes a method for determining an optical phase difference of a sub-signal of an optical transmitter and some hardware structures for implementing the method, however the present disclosure is not limited to this. The method for determining an optical phase difference of a sub-signal of an optical transmitter may further include other operations or processes. For specific contents of these operations or processes, please refer to prior arts. In addition, the above text exemplarily describes hardware structures for implementing the method for determining an optical phase difference of a sub-signal of an optical transmitter, however the present disclosure is not limited to these hardware structures, these structures may further be modified appropriately, implementations of such modifications should be included within the scope of the embodiments of the present disclosure.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, in the present disclosure, an optical phase difference is determined using a signal output by an electro-optical conversion unit of an optical transmitter, there is no need for the optical transmitter to transmit a special signal, implementation is simple; in the present disclosure, a low-speed electrical device is be used to realize monitoring of an optical phase difference of sub-signals of the optical transmitter, avoiding use of a high-speed equipment, and the low-speed electrical device may be set up in an integrated or non-integrated way, an implementation mode is flexible; in addition, the present disclosure is applicable to sub-signal optical phase difference monitoring in a variety of optical transmitters, application scenarios is diverse.

### Embodiments of a Second Aspect

The embodiments of the present disclosure provide an apparatus for determining an optical phase difference of a sub-signal of an optical transmitter, the contents same as the embodiments of the first aspect are not repeated.

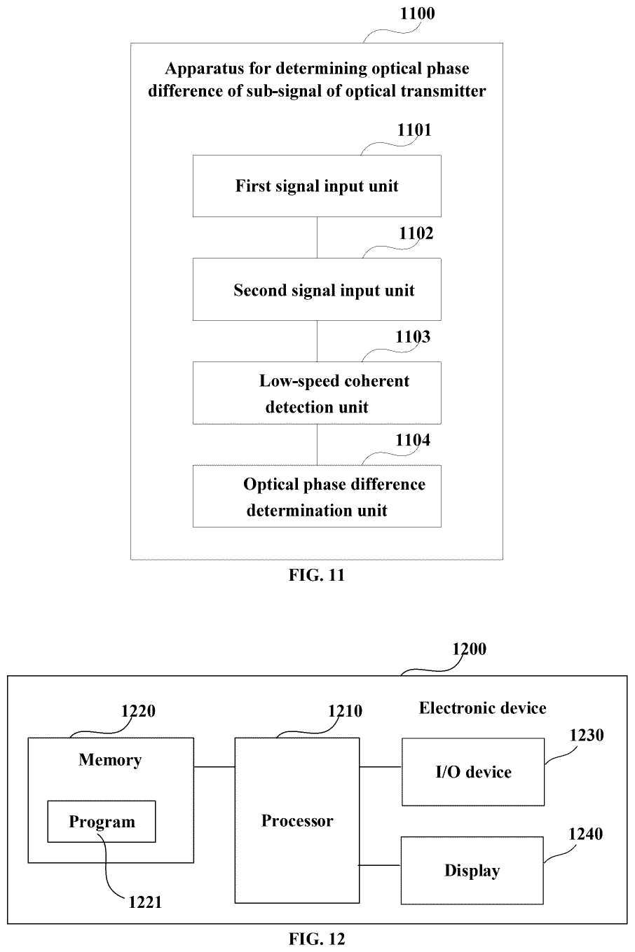

FIG. 11 is a schematic diagram of an apparatus for determining an optical phase difference of a sub-signal of an optical transmitter in the embodiments of the present disclosure. As shown in FIG. 11, an apparatus for determining an optical phase difference of a sub-signal of an optical transmitter includes:
a first signal input unit 1101, configured to input a first input signal to a first electro-optical conversion unit, to enable the first electro-optical conversion unit to modulate to-be-modulated light according to the first input signal to obtain a first output signal;
a second signal input unit 1102, configured to input a second input signal to a second electro-optical conversion unit, to enable the second electro-optical conversion unit modulates to-be-modulated light according to the second input signal to obtain a second output signal, wherein correlation of the second input signal and the first input signal is not 0;
a low-speed coherent detection unit 1103, configured to perform a coherent detection operation based on the first output signal and the second output signal to obtain a first output quantity and a second output quantity; and
an optical phase difference determination unit 1104, configured to determine an optical phase difference of an output signal of the first electro-optical conversion unit and an output signal of the second electro-optical conversion unit according to the first output quantity and the second output quantity.

In some embodiments, the first electro-optical conversion unit is a transmitter, or a partial modulation unit of the transmitter.

In some embodiments, the second electro-optical conversion unit outputs a finite number of states.

In some embodiments, the second input signal is the same as the first input signal; or
the second input signal is a weighted sum of the first input signal at a plurality of different moments; or
the second input signal is a symbol sequence of the weighted sum of the first input signal at a plurality of different moments; or
the second input signal is a product of the symbol sequence of the weighted sum of the first input signal at a plurality of different moments and a random amplitude sequence.

In some embodiments, the first electro-optical conversion unit is connected in parallel to the second electro-optical conversion unit, and the first electro-optical conversion unit is connected to a first input end of the low-speed coherent detection unit 1103, and inputs the first output signal to the first input end, the second electro-optical conversion unit is connected to a second input end of the coherent detection unit, and inputs the second output signal to the second input end;
and, the low-speed coherent detection unit 1103 is specifically used to:
perform a coherent detection operation on the first output signal and the second output signal to obtain the first output quantity and the second output quantity.

In some embodiments, the first electro-optical conversion unit is connected in series to the second electro-optical conversion unit, and a series structure of the first electro-optical conversion unit and the second electro-optical conversion unit is connected to the first input end of the low-speed coherent detection unit 1103, and the product of the first output signal and the second output signal is input to the first input end, the second input end of the low-speed coherent detection unit 1103 inputs a pre-set reference signal;
and, the low-speed coherent detection unit 1103 is specifically used to:
perform a coherent detection operation on the product of the first output signal and the second output signal as well as the reference signal to obtain the first output quantity and the second output quantity.

In some embodiments, the optical phase difference determination unit is specifically used to:
substitute the first output quantity and the second output quantity into the following formula to obtain the optical phase difference:

$$φ = arg ( {I}_{1} - j {I}_{2} )$$

where, I₁ is the first output quantity, I₂ is the second output quantity, φ is an optical phase difference of the output signal of the first electro-optical conversion unit and the output signal of the second electro-optical conversion unit, and arg (z) is a principal argument angle of a complex number z.

In some embodiments, the apparatus further includes (not shown):
a first product unit, configured to multiply the second input signal with a low-frequency square wave before the second input signal is input to the second electro-optical conversion unit; two input ends of the first product unit respectively input a second input signal and a low-frequency square wave, and the output end of the first product unit is connected to the second signal input unit 1102, and outputs a product of the second input signal and the low-frequency square wave; and
a second product unit, configured to multiply the first output quantity and the second output quantity with the low-frequency square wave respectively, before the optical phase difference is determined according to the first output quantity and the second output quantity; the number of the second product units is two, two input ends of one of the second product units respectively input a low-frequency square wave and a first output quantity output by an optical phase difference determination unit, an output end outputs a product of the first output quantity and the low-frequency square wave; two input ends of the other one of the second product units respectively input a low-frequency square wave and a second output quantity output by the optical phase difference determination unit, an output end outputs a product of the second output quantity and the low-frequency square wave;
and the second signal input unit 1102 is further used to input a product signal of the second input signal and the low-frequency square wave to the second electro-optical conversion unit; and
the optical phase difference determination unit 1104 is further used to determine the optical phase according to the product of the first output quantity and the low-frequency square wave and the product of the second output quantity and the low-frequency square wave.

In some embodiments, the second signal input unit 1102 is further used to: at a pre-set moment, input the second input signal to the second electro-optical conversion unit; and at a moment other than the pre-set moment, input a signal with correlation being 0 with the first input signal or a 0 signal to the second electro-optical conversion unit.

It's worth noting that the above only describes components or modules related to the present disclosure, but the present disclosure is not limited to this. The apparatus 1100 for determining an optical phase difference of a sub-signal of an optical transmitter may further include other components or modules. For detailed contents of these components or modules, relevant technologies may be referred to.

For the sake of simplicity, FIG. 11 only exemplarily shows a connection relationship or signal direction between components or modules, however persons skilled in the art should know that various relevant technologies such as bus connection may be used. The above components or modules can be realized by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, in the present disclosure, an optical phase difference is determined using a signal output by an electro-optical conversion unit of an optical transmitter, there is no need for the optical transmitter to transmit a special signal, implementation is simple; in the present disclosure, a low-speed electrical device is be used to realize monitoring of an optical phase difference of sub-signals of the optical transmitter, avoiding use of a high-speed equipment, and the low-speed electrical device may be set up in an integrated or non-integrated way, an implementation mode is flexible; in addition, the present disclosure is applicable to sub-signal optical phase difference monitoring in a variety of optical transmitters, application scenarios is diverse.

### Embodiments of a Third Aspect

The embodiments of the present disclosure provide an electronic device, including the apparatus 1100 for determining an optical phase difference of a sub-signal of an optical transmitter as described in the embodiments of the second aspect, whose contents are incorporated here. The electronic device may be, for example, a computer, server, a workstation, a laptop computer, a smartphone, etc.; however, the embodiments of the present disclosure are not limited to this.

FIG. 12 is a schematic diagram of an electronic device in the embodiments of the present disclosure. As shown in FIG. 12, an electronic device 1200 may include: a processor (such as a central processing unit (CPU)) 1210 and a memory 1220; the memory 1220 is coupled to the central processing unit 1210. The memory 1220 may store various data; moreover, further stores a program 1221 for information processing, and executes the program 1221 under the control of the processor 1210.

In some embodiments, the function of the apparatus 1100 for determining an optical phase difference of a sub-signal of an optical transmitter is integrated into the processor 1210 for implementation. The processor 1210 is configured to implement the method for determining an optical phase difference of a sub-signal of an optical transmitter as described in the embodiments of the first aspect.

In some embodiments, the apparatus 1100 for determining an optical phase difference of a sub-signal of an optical transmitter is configured separately from the processor 1210, for example the apparatus 1100 for determining an optical phase difference of a sub-signal of an optical transmitter is configured as a chip connected to the processor 1210, a function of the apparatus 1100 for determining an optical phase difference of a sub-signal of an optical transmitter is realized through the control of the processor 1210.

For example, the processor 1210 is configured to perform the following control:
input a first input signal to a first electro-optical conversion unit, to enable the first electro-optical conversion unit to modulate to-be-modulated light according to the first input signal and to obtain a first output signal; input a second input signal to a second electro-optical conversion unit, to enable the second electro-optical conversion unit to modulate to-be-modulated light according to the second input signal and to obtain a second output signal, wherein correlation of the second input signal and the first input signal is not 0; perform a coherent detection operation based on the first output signal and the second output signal to obtain a first output quantity and a second output quantity; and determine an optical phase difference of an output signal of the first electro-optical conversion unit and an output signal of the second electro-optical conversion unit according to the first output quantity and the second output quantity.

In addition, as shown in FIG. 12, the electronic device 1200 may further include: an input/output (I/O) device 1230 and a display 1240, etc., wherein the functions of said components are similar to relevant arts, and are not repeated here. It's worth noting that the electronic device 1200 does not have to include all the components shown in FIG. 12. Moreover, the electronic device 1200 may also include components not shown in FIG. 12, relevant technologies may be referred to.

The embodiments of the present disclosure further provide a computer readable program, wherein when an electronic device executes the program, the program enables a computer to execute the method for determining an optical phase difference of a sub-signal of an optical transmitter as described in the embodiments of the first aspect, in the electronic device.

The embodiments of the present disclosure further provide a storage medium in which a computer readable program is stored, wherein the computer readable program enables a computer to execute the method for determining an optical phase difference of a sub-signal of an optical transmitter as described in the embodiments of the first aspect, in the electronic device.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or operations described in the above text. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the operations as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the principle of the present disclosure, these variations and modifications are also within the scope of the present disclosure.

As for the implementations including the above embodiments, the following supplements are further disclosed:

Supplement 1. A method for determining an optical phase difference of a sub-signal of an optical transmitter, the method including:
inputting a first input signal to a first electro-optical conversion unit, to enable the first electro-optical conversion unit to modulate to-be-modulated light according to the first input signal to obtain a first output signal;
inputting a second input signal to a second electro-optical conversion unit, to enable the second electro-optical conversion unit to modulate to-be-modulated light according to the second input signal to obtain a second output signal, wherein correlation of the second input signal and the first input signal is not 0;
performing a coherent detection operation based on the first output signal and the second output signal to obtain a first output quantity and a second output quantity; and
determining an optical phase difference of an output signal of the first electro-optical conversion unit and an output signal of the second electro-optical conversion unit according to the first output quantity and the second output quantity.

Supplement 2. The method according to Supplement 1, wherein the first electro-optical conversion unit is a transmitter, or a partial modulation unit of the transmitter.

Supplement 3. The method according to Supplement 1, wherein the second electro-optical conversion unit outputs a finite number of states.

Supplement 4. The method according to Supplement 1, wherein
the second input signal is the same as the first input signal; or
the second input signal is a weighted sum of the first input signal at a plurality of different moments; or
the second input signal is a symbol sequence of a weighted sum of the first input signal at a plurality of different moments; or
the second input signal is a product of a symbol sequence of a weighted sum of the first input signal at a plurality of different moments and a random amplitude sequence.

Supplement 5. The method according to Supplement 1, wherein performing a coherent detection operation based on the first output signal and the second output signal to obtain a first output quantity and a second output quantity includes:
performing a coherent detection operation on the first output signal and the second output signal to obtain the first output quantity and the second output quantity.

Supplement 6. The method according to Supplement 1, wherein performing a coherent detection operation based on the first output signal and the second output signal to obtain a first output quantity and a second output quantity includes:
performing a coherent detection operation on a product of the first output signal and the second output signal as well as a pre-set reference signal to obtain the first output quantity and the second output quantity.

Supplement 7. The method according to Supplement 1, wherein determining an optical phase difference of an output signal of the first electro-optical conversion unit and an output signal of the second electro-optical conversion unit according to the first output quantity and the second output quantity includes:
substituting the first output quantity and the second output quantity into the following formula to obtain the optical phase difference:

$$φ = arg ( {I}_{1} - j {I}_{2} )$$

where, I₁ is the first output quantity, I₂ is the second output quantity, φ is an optical phase difference of the output signal of the first electro-optical conversion unit and the output signal of the second electro-optical conversion unit, and arg (z) is a principal argument angle of a complex number z.

Supplement 8. The method according to Supplement 1, wherein the method further includes:
before the second input signal is input to the second electro-optical conversion unit, multiplying the second input signal with a low-frequency square wave, and inputting a product signal of the second input signal and the low-frequency square wave to the second electro-optical conversion unit; and
before the optical phase difference is determined according to the first output quantity and the second output quantity, multiplying the first output quantity and the second output quantity with the low-frequency square wave respectively, and determining the optical phase according to the product of the first output quantity and the low-frequency square wave and the product of the second output quantity and the low-frequency square wave.

Supplement 9. The method according to Supplement 1, wherein at a pre-set moment, input the second input signal to the second electro-optical conversion unit; and at a moment other than the pre-set moment, input a signal with correlation being 0 with the first input signal or a 0 signal to the second electro-optical conversion unit.

Supplement 10. An electronic device, including a memory and a processor, the memory storing a computer program, and the processor being configured to execute the computer program to implement a method for determining an optical phase difference of a sub-signal of an optical transmitter according to any one of Supplements 1 to 9.

Supplement 11. A storage medium storing a computer readable program, wherein the computer readable program enables a computer to execute a method for determining an optical phase difference of a sub-signal of an optical transmitter according to any one of Supplements 1 to 9, in an electronic device.

1. An apparatus for determining an optical phase difference of a sub-signal of an optical transmitter, comprising:
a memory; and
a processor coupled to the memory to:
input a first input signal to a first electro-optical conversion unit, to enable the first electro-optical conversion unit to modulate to-be-modulated light according to the first input signal and to obtain a first output signal;
input a second input signal to a second electro-optical conversion unit, to enable the second electro-optical conversion unit to modulate to-be-modulated light according to the second input signal and to obtain a second output signal, wherein correlation of the second input signal and the first input signal is not 0;
perform a coherent detection operation based on the first output signal and the second output signal to obtain a first output quantity and a second output quantity; and
determine an optical phase difference of an output signal of the first electro-optical conversion unit and an output signal of the second electro-optical conversion unit according to the first output quantity and the second output quantity.

2. The apparatus according to claim 1, wherein the first electro-optical conversion unit is a transmitter, or a partial modulation unit of the transmitter.

3. The apparatus according to claim 1, wherein the second electro-optical conversion unit outputs a finite number of states.

4. The apparatus according to claim 1, wherein
the second input signal is same as the first input signal; or
the second input signal is a weighted sum of the first input signal at a plurality of different moments; or
the second input signal is a symbol sequence of a weighted sum of the first input signal at a plurality of different moments; or
the second input signal is a product of a symbol sequence of a weighted sum of the first input signal at a plurality of different moments and a random amplitude sequence.

5. The apparatus according to claim 1, wherein the first electro-optical conversion unit is connected in parallel to the second electro-optical conversion unit, and the first electro-optical conversion unit is connected to a first input end of a low-speed coherent detection unit, and inputs the first output signal to the first input end, and the second electro-optical conversion unit is connected to a second input end of the low-speed coherent detection unit, and inputs the second output signal to the second input end; and
the low-speed coherent detection unit is further configured to:
perform a coherent detection operation on the first output signal and the second output signal to obtain the first output quantity and the second output quantity.

6. The apparatus according to claim 1, wherein the first electro-optical conversion unit is connected in series to the second electro-optical conversion unit, and a series structure of the first electro-optical conversion unit and the second electro-optical conversion unit is connected to a first input end of a low-speed coherent detection unit, and inputs a product of the first output signal and the second output signal to the first input end, and a second input end of the low-speed coherent detection unit is input a pre-set reference signal, and
the low-speed coherent detection unit is further configured to:
perform a coherent detection operation on the product of the first output signal and the second output signal as well as the pre-set reference signal to obtain the first output quantity and the second output quantity.

7. The apparatus according to claim 1, wherein the processor configured to:
substitute the first output quantity and the second output quantity into a formula, to obtain the optical phase difference, as follows:
$$φ = arg ( {I}_{1} - j {I}_{2} )$$
where, I₁ is the first output quantity, I₂ is the second output quantity, φ is an optical phase difference of the output signal of the first electro-optical conversion unit and the output signal of the second electro-optical conversion unit, and arg (z) is principal argument angle of a complex number z.

8. The apparatus according to claim 1, wherein the processor is further configured to:
multiply the second input signal with a low-frequency square wave before the second input signal is input to the second electro-optical conversion unit; and
multiply the first output quantity and the second output quantity with the low-frequency square wave respectively, before the optical phase difference is determined based on the first output quantity and the second output quantity; and
the processor is further configured to:
input a product signal of the second input signal and the low-frequency square wave to the second electro-optical conversion unit; and
determine the optical phase difference according to a product of the first output quantity and the low-frequency square wave and a product of the second output quantity and the low-frequency square wave.

9. The apparatus according to claim 1, wherein the processor is further configured to:
pre-set input, at a pre-set moment, the second input signal to the second electro-optical conversion unit; and
input, at a moment other than the pre-set moment, a signal with correlation of 0 with the first input signal, or a 0 signal to the second electro-optical conversion unit.

10. A method for determining an optical phase difference of a sub-signal of an optical transmitter, the method comprising:
inputting a first input signal to a first electro-optical conversion unit, to enable the first electro-optical conversion unit to modulate to-be-modulated light according to the first input signal and to obtain a first output signal;
inputting a second input signal to a second electro-optical conversion unit, to enable the second electro-optical conversion unit to modulate to-be-modulated light according to the second input signal and to obtain a second output signal, wherein correlation of the second input signal and the first input signal is not 0;
performing a coherent detection operation based on the first output signal and the second output signal to obtain a first output quantity and a second output quantity; and
determining an optical phase difference of an output signal of the first electro-optical conversion unit and an output signal of the second electro-optical conversion unit according to the first output quantity and the second output quantity.
